(19) United States
(12) Patent Application Publication
(10) Pub. No.: US 2006/0140444 A1
(43) Pub. Date: Jun. 29, 2006

(54) Human face identification means in security system

(76) Inventor: Yih-Ran Sheu, Tainan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/020,101

(22) Filed: Dec. 27, 2004

(51) Int. Cl. G06K 9/00; G06K 9/36

(52) U.S. Cl. 382/103; 382/118; 382/291

(57) ABSTRACT

A means in a security system to identify a genuine human face includes: a) generating a subject picture to be tested; b) determining if the subject picture gives features of a human face; e) if yes, the temperature in the subject picture being detected; and f) comparing the detected temperature with a reference temperature, and determining that the subject picture is a genuine human face if the difference resulted from the comparison falls within a pre-set range of error.

### BACKGROUND OF THE INVENTION

(a) Field of the Invention

The present invention relates to an identification means, and more particularly to one applied in a security system to identify a genuine human face by image analysis in conjunction with the temperature of the human face.

(b) Description of the Prior Art

A security system is generally designed to prevent illegal act at a specific location. For example, a bank usually maintains multiple ATMs to service its clients. ATM for being deposited with a lot of money and usually left unattended becomes a perfect target for the outlaw. If the security system adapted to the ATM is sufficient to identify the outlaw, the chance that the ATM becomes loot is minimized.

At present, 24H videotape to monitor the ATM is usually made available to help the police solve the case of break in. However, if the outlaw wears a respirator or a helmet, the videotaped image is rendered useless for failing to clearly identify the look of the outlaw.

An improvement is made by the same inventor to provide an image identification means by judging if the ATM user gives the facial features. If yes, the user is authorized to use the ATM; or if not, the alarm process is activated to carry on the protection procedure to identify if the user is a legal one and thus to frustrate criminality.

However, if the subject wears a facial mask, he or she may fool the detection of facial features. The security system still fails to identify the facial features of the outlaw from the image identified.

Whereas the human being maintains constant body temperature and the temperature of his/her face is close to that of his/her body. The temperature of the mask for not being part of the human body is somehow close to the ambient temperature and thus different from the body temperature of a human being. Taking advantage of this difference, the present invention excludes the possibility of fooling the detection by wearing a facial mask to identify a legal subject by image and measurement of body temperature.

It is to be noted that the present invention is applicable in other security system deployed at various locations and under different situations, e.g., the access to a bank, a jewelry store or a pawnshop where the same problem of identifying an outlaw wearing a mask also exists.

### SUMMARY OF THE INVENTION

The primary purpose of the present invention is to provide a means adapted in a security system to correctly identify a human face. To achieve the purpose, the means operates in the following steps:
a) generating a picture of the subject approaching the security system;
b) judging if the picture shows features of a human face;
c) if the face features are identified as true, the means continues to detect the temperature of the subject in the picture; and
d) comparing the temperature measured with a reference temperature, if the difference falls within a specified allowance, it is determined as a genuine human face.

### BRIEF DESCRIPTION OF THE DRAWINGS

FIG. 1 is a schematic view showing a preferred embodiment of the present invention.

FIGS. 2A and 2B are the flow charts of the preferred embodiment of the present invention.

### DETAILED DESCRIPTION OF THE PREFERRED EMBODIMENTS

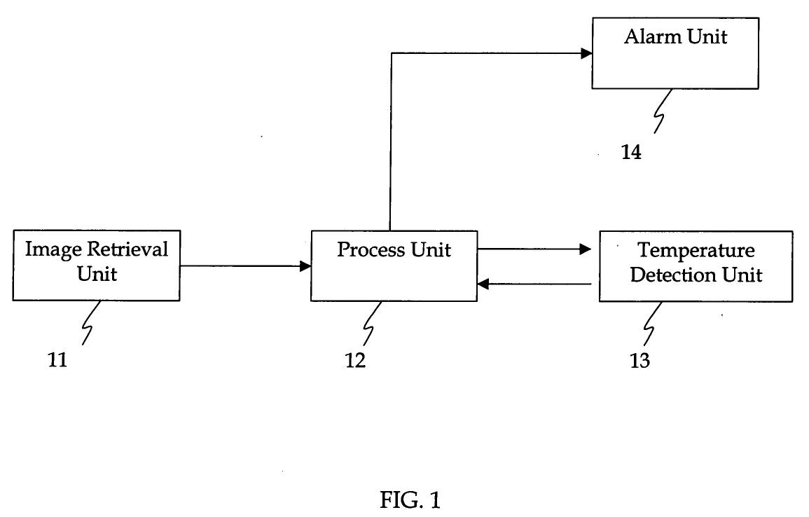

Referring to FIG. 1 for a preferred embodiment of the present invention of a human face identification means adapted to a security system to detect whether a subject is legally authorized. The identification means includes an image unit 11 to retrieve image, a process unit 12 to process the image retrieved, a temperature detection unit 13 to receive commands transmitted from the process unit 12, and an alarm unit 14 linked to the process unit 12 for telecommunication.

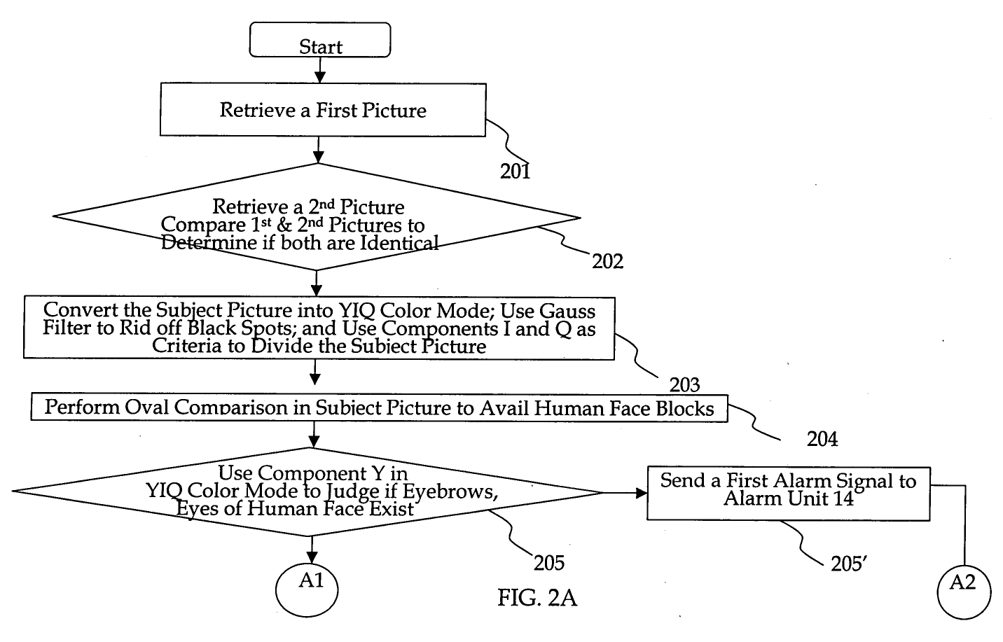

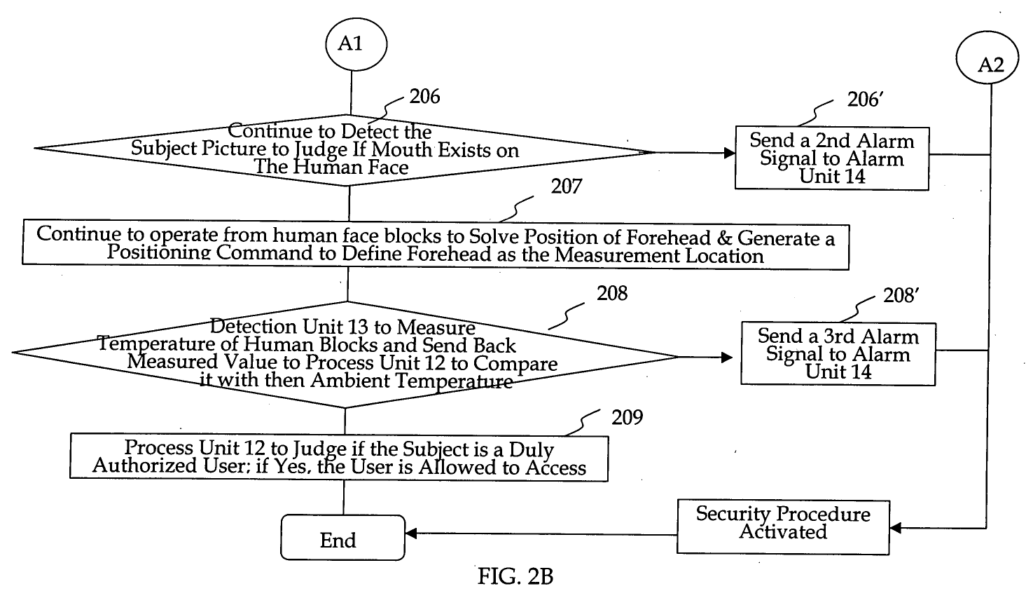

As illustrated in FIG. 2, the present invention operates in the following steps.

In Step 201, the image unit 11 retrieves a first picture and sends it to the process unit 12 for storage.

In Step 202, the image unit 11 continues to retrieve a second picture and send it to the process unit 12 for comparing it with the first picture.

Both of the first and the second pictures are retrieved and stored in the format of RGB (Red-Green-Blue) color mode. Depending on the comparison, if both of the first and the second pictures are identical, the process returns to perform Step 201. If both of the first and the second pictures are different, it indicates that a subject appears in the second picture, and the second picture is used as the subject picture in the subsequent steps.

In Step 203, the process unit 12 converts the subject picture from the RGB color mode into YIQ color mode while Gauss filter is used to remove spots, and components Q and I are used as the criteria to divide the subject picture to locate the blocks of the skin color of the human being.

The present invention is not limited to YIQ mode. YUV and HSI color modes that are less subject to light are also applicable. In YUV mode, components U and V are used as the criteria to divide the subject picture; and HSI mode, components H and S.

In YIQ color mode, Y standing for luminance; I for inphase; and Q for quad-rature are essentially applied in the signal communication of color cabled TV system.

YUV color mode adapted by European TV system belongs to PAL system. Wherein Y stands for luminance, i.e. gray scale value while U and V stand for chrominance to describe the color and saturation attributes of image. In HSI color mode, H stands for hue, S, for saturation, and I, intensity.

After blocks of skin color are distinguished, the process goes to Step 204 to immediately perform oval comparison for further precise comparison of the possible position of the human face of the subject thus to obtain blocks of a human face.

In Step 205, the process unit 12 scans the blocks of human face starting from the upper boundary downward to tell from the blocks of the human face availed in the preceding step the presence of eyebrows and eyes using component Y in YIQ color mode. IN YUV mode, Step 205 searches for component Y, and HSI mode, component I.

In the judgment process, it is considered that component Y of the facial features of an average is the most prominent in YIQ color mode, component Y in YUV mode, and component I in HSI mode. Therefore, component Y can be used to locate the positions of eyebrows and eyes, i.e., those areas where black spots arranged laterally in symmetry in the subject picture. In failure to tell the region where black spots gather, the process unit 12 concludes the absence of facial feature of human in the blocks of the subject picture, meaning the subject may cover his/her face with a mask. Since the subject is not a duly authorized person, the process goes to Step 205′. Wherein, the process unit 12 sounds a first alarm signal to the alarm unit 14 to activate subsequent security responses. On the contrary, if the region where black spots gather is identified, the process continues to the next Step 206.

In Step 206, the process unit 12 continues to detect another location whether lateral black spots gather to determine the presence of a mouth on the subject picture.

Again, the process goes to Step 206′ if the location of the mouth is not detected, meaning the mouth is masked. In Step 206′, the process unit 12 sends a second alarm signal to the alarm unit 14 to activate the subsequent security responses.

If the location of the mouth is detected, the process goes to Step 207. The process 12 continues to operate for locating the position of the forehead from the blocks of the human face, and generates a positioning command to define the forehead functioning as the measurement position.

In Step 207, the preliminary position of the forehead of the blocks of the human face is availed from the region between the upper boundaries of location of the eyes or the eyebrows and the human body in conjunction with the central position between the left and the right boundaries of the blocks of the human face.

The process unit 12 in the next Step 208 gives the positioning command to instruct the temperature detection unit 13 to measure the temperature of the blocks of the human body to generate a measured value.

In the preferred embodiment, the temperature detection unit 13 is an infrared thermometer, or a body surface temperature sense device.

The measured value is transmitted back to the process unit 12 to compare with the ambient temperature at that time. Should the measured value be close to the ambient temperature, the process goes to the next Step 208′, wherein, the process unit 12 sends a third alarm signal to the alarm unit 14 to activate the subsequent security responses.

If difference is found between the measured value and the ambient temperature is detected, and the result of comparison of the measured value and a pre-determined body temperature reference indicates that the difference is not greater than a reasonable range of error, the process goes to Step 209. Wherein, the process unit 12 determines whether the subject is a legally authorized user. If yes, the user is authorized to operate the system, e.g., an ATM.

The present invention is characterized by that the identification means first determines the position respectively of eyebrows, eyes and mouth on the face of the subject to properly judge whether the subject is a genuine human face in conjunction with the detection of the temperature of the human face.

Furthermore, when the first, the second, and the third alarm signals are transmitted to the alarm unit 14, the pre-set responses are activated to directly dial the local police for the police to have sufficient time to rush to the scene; to transmit message to the controller and the control center; and to sound the deterrence audible signals in conjunction with the present invention.

Accordingly, when the subject wears a mouthpiece, mask, or helmet, the process unit 12 will fail to detect the main features of eyebrows, eyes, and mouth on the human face, and the temperature detection unit 13 also will fail to detect the surface temperature of the human face. Accordingly, the alarm unit 14 alerts the controller, and even directly sounds the alarm to fend off the illegal user to achieve the purpose and results of the present invention. Besides, the active alarm or dial is far safer than the manual operation of the alarm device. The controller may release the alarm once it is found that the subject presents no threats.

Alternatively, a sensor may be mounted at a pre-set location to activate the image unit 11, and the retrieved picture may be also applied as the subject picture.

What is claimed is:

1. A means in a security system to identify a genuine human face comprising:
a) generating a subject picture to be tested;
b) determining if the subject picture gives features of a human face;
c) if yes, the temperature in the subject picture being detected; and
d) comparing the detected temperature with a reference temperature, and determining that the subject picture is a genuine human face if the difference resulted from the comparison falls within a pre-set range of error.

2. The means in a security system to identify a genuine human face of claim 1, wherein Step a) is performed in the following sequence:
a1) retrieving a first picture;
a2) retrieving a second picture after a given lapse of time; and
a3) if the second picture is different from the first picture, the second picture being applied as the subject picture to be tested.

3. The means in a security system to identify a genuine human face of claim 1, wherein Step c) is a detection of the temperature of the human face blocks.

4. The means in a security system to identify a genuine human face of claim 1, wherein Step e) is to sound an alarm signal once it is determined that the subject picture is not a genuine human face.

5. The means in a security system to identify a genuine human face of claim 1, wherein Step a) is to sense a subject to generate a subject picture; the subject picture being given an oval comparison to generate human face blocks; and Step b) determining whether the human face blocks in the subject picture give the features of a genuine human face.
